(19) United States
(12) Patent Application Publication
(10) Pub. No.: US 2024/0028359 A1
(43) Pub. Date: Jan. 25, 2024

(54) REDUCING CPU EXECUTION CONTEXT TRANSITIONS ACROSS PRIVILEGE LEVELS FOR USER LEVEL HYPERVISORS

(71) Applicant: VMware, Inc., Palo Alto, CA (US)

(72) Inventors: Sam Scalise, San Jose, CA (US); Frederick Joseph Jacobs, Los Gatos, CA (US); James Kenneth White, Lake Stevens, WA (US)

(21) Appl. No.: 17/868,650

(22) Filed: Jul. 19, 2022

(51) Int. Cl. G06F 9/455

(52) U.S. Cl. CPC G06F 9/45558; G06F 2009/45587

(57) ABSTRACT

In one set of embodiments, new hardware-assisted virtualization features for a CPU are provided that include, among other things: (1) a new control structure that allows a kernel level hypervisor component to set, for each configurable property/setting maintained in an existing control structure, whether the property/setting is accessible from an unprivileged hypervisor mode of the CPU, (2) another new control structure that allows the kernel level hypervisor component to set, for each of a plurality of guest events or operations, whether the guest event or operation will cause a transition from a privileged or unprivileged guest mode of the CPU to the unprivileged hypervisor mode, and (3) the ability for the CPU to transition directly from the unprivileged hypervisor mode to the privileged or unprivileged guest mode.

### BACKGROUND

Unless otherwise indicated, the subject matter described in this section is not prior art to the claims of the present application and is not admitted as being prior art by inclusion in this section.

Hypervisors have traditionally been run entirely in the most privileged central processing unit (CPU) execution context (often referred to as kernel mode because operating system kernels also run in such a mode). Although this was originally done out of necessity, in recent years there has been growing interest in running hypervisors in a less privileged CPU execution context (often referred to as user mode). There are several driving forces for this change. First, it results in a reduced attack surface, as any code running in kernel mode can potentially become a vector for attack. Second, a large number of tasks performed by hypervisors do not require privileged access to system resources and thus can easily be run in user mode. Third, by moving towards a user level hypervisor, certain software simplifications can be achieved within the hypervisor that enable faster and more efficient operation.

One challenge with implementing a user level hypervisor on existing CPU architectures is that, due to the particular hardware virtualization execution modes and mechanisms for controlling those modes supported by such CPUs, there is a significant increase in transitions between more privileged and less privileged CPU execution contexts. This increase in transitions across different privilege levels can lead to noticeable drops in performance.

### BRIEF DESCRIPTION OF THE DRAWINGS

FIG. 1 depicts an example computer system.

FIG. 2 depicts an example hypervisor including a kernel level component and a user level component according to certain embodiments.

FIGS. 3A and 3B depict scenarios in which increased CPU execution context transitions across privilege levels occur due to the user level hypervisor component of FIG. 2.

FIG. 4 depicts a modified version of the computer system of FIG. 1 comprising an enhanced CPU with new hardware-assisted virtualization features according to certain embodiments.

FIGS. 5A and 5B depict the scenarios of FIGS. 3A and 3B when the new hardware assisted-virtualization features are enabled according to certain embodiments.

FIG. 6 depicts a workflow for enabling user level hypervisor access to guest mode properties/settings according to certain embodiments.

FIG. 7 depicts a workflow for performing direct unprivileged hypervisor mode to guest mode transitions according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to new CPU hardware features and associated workflows that advantageously reduce the number of CPU execution context transitions across privilege levels necessitated by a user level hypervisor (or in other words, a hypervisor that runs in user mode). As used herein, a “CPU execution context” is a runtime state of a CPU, including its program counter and all of its registers, and is associated with a privilege level indicating the degree of access the CPU has to system resources while running in that context. The most privileged CPU execution context is generally known as kernel mode and a less privileged CPU execution context is generally known as user mode.

### 1. Example Computer System and Solution Overview

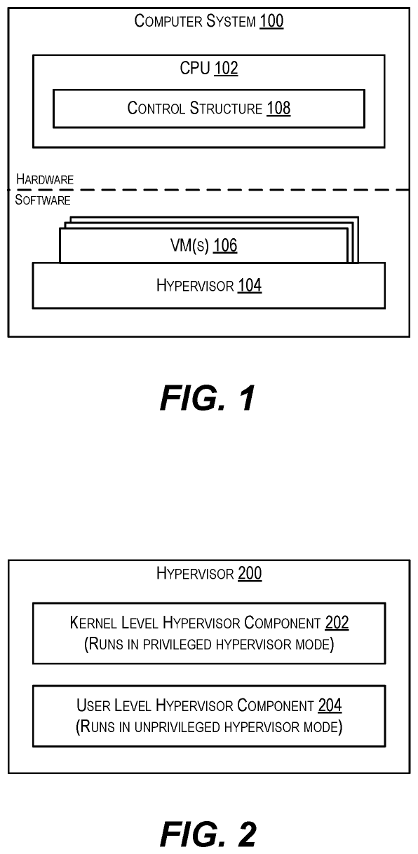

FIG. 1 is a simplified block diagram of an example computer system 100 in which the embodiments of the present disclosure may be implemented. As shown, computer system 100 includes a CPU 102 in hardware and a hypervisor 104 (also known as a virtual machine monitor or VMM) in software that provides an environment for running one or more virtual machines (VMs) 106. Examples of hypervisor 104 include VMware ESXi, Microsoft Hyper-V, Citrix Xen, and the like.

Many modern CPUs implement a set of hardware features, collectively referred to as hardware-assisted virtualization, that facilitate the operation of hypervisors and their VMs. For example, hardware-assisted virtualization provides four CPU execution modes that correspond to four separate types of CPU execution contexts for running hypervisor software and guest (i.e., VM level) software respectively: (1) a privileged hypervisor mode for running hypervisor code in the most privileged CPU execution context (i.e., kernel mode), (2) an unprivileged hypervisor mode for running hypervisor code in a less privileged CPU execution context (i.e., user mode), (3) a privileged guest mode for running guest code in a context where it perceives itself to have full privileges but the hypervisor remains isolated/protected, and (4) an unprivileged guest mode for running guest code in user mode.

Hardware-assisted virtualization also provides a control structure, shown within CPU 102 of FIG. 1 via reference numeral 108, that enables a hypervisor to configure, while running on the CPU in privileged hypervisor mode, various properties of the privileged/unprivileged guest modes and thereby control the execution contexts of VMs. These properties include, e.g., what CPU features guest code is allowed or not allowed to use while running in the privileged/unprivileged guest modes, as well as what guest events and/or operations will cause the CPU to transition from one of those guest modes to privileged hypervisor mode. In the case of the x86 CPU architecture, control structure 108 takes the form of a data structure comprising a plurality of fields corresponding to the various configurable properties/settings.

As mentioned previously, existing hypervisors generally run entirely in the most privileged CPU execution context, which is privileged hypervisor mode on CPUs with hardware-assisted virtualization. However, for reasons such as security, software simplification, and so on, it has become increasingly desirable to move at least a portion of the functionality of hypervisors to unprivileged hypervisor mode. For example, FIG. 2 depicts a version of hypervisor 104 of FIG. 1, identified via reference numeral 200, that includes a kernel level hypervisor component 202 and a user level hypervisor component 204 according to certain embodiments. Kernel level hypervisor component 202 is configured to execute the tasks of hypervisor 200 that require full system privileges and thus runs on CPU 102 in privileged hypervisor mode. In contrast, user level hypervisor component 204 is configured to execute the tasks of hypervisor 200 that do not require full system privileges and thus runs on CPU 102 in unprivileged hypervisor mode.

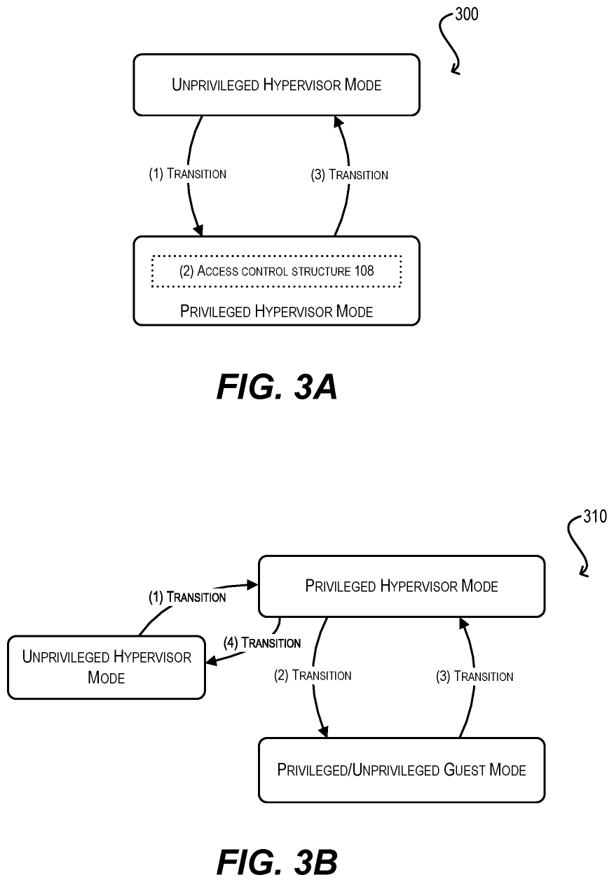

An issue with the hypervisor design shown in FIG. 2 is that, with existing CPU architectures, hypervisor 200 can only access the settings in control structure 108 while the hypervisor is running in privileged hypervisor mode on CPU 102 (or in other words, while executing kernel level hypervisor component 202); it cannot do so while running in unprivileged hypervisor mode. As a result, if hypervisor 200 is running on CPU 102 in unprivileged hypervisor mode via user level hypervisor component 204 at the time of needing to read or write a property/setting in control structure 108, it must first transition to privileged hypervisor mode via kernel level hypervisor component 202, perform the access operation, and then transition back to unprivileged hypervisor mode/user level hypervisor component 204. This is illustrated as scenario 300 in FIG. 3A.

Another issue is that, with existing CPU architectures, any CPU transition from a hypervisor mode to a guest mode must be initiated from privileged hypervisor mode; this transition cannot be performed directly from unprivileged hypervisor mode. Similarly, any CPU return (i.e., exit) from a guest mode to a hypervisor mode must go to privileged hypervisor mode. As a result, if hypervisor 200 is running in unprivileged hypervisor mode via user level hypervisor component 204 at the time of needing to switch CPU control to either privileged guest mode or unprivileged guest mode, CPU 102 must first transition to privileged hypervisor mode via kernel level hypervisor component 202 and then transition to privileged/unprivileged guest mode. Further, upon exiting the guest mode, the only option is to return to privileged hypervisor mode. Accordingly, if the intention is to return to unprivileged hypervisor mode, yet another transition is required from privileged hypervisor mode to unprivileged hypervisor. This is illustrated as scenario 310 in FIG. 3B. The combination of these two issues leads to a significant increase in CPU transitions between more privileged and less privileged CPU execution contexts (or in other words, between the privileged and unprivileged hypervisor modes) and thus a noticeable decrease in performance for hypervisor 200.

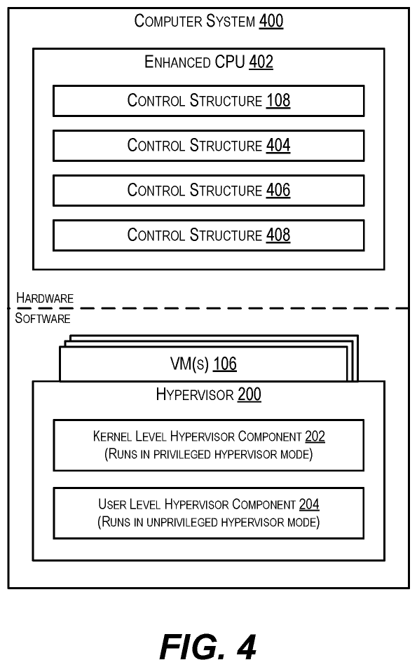

To address the foregoing, FIG. 4 depicts a modified version of computer system 100 of FIG. 1, identified via reference numeral 400, that includes hypervisor 200 of FIG. 2 (comprising kernel level and user level hypervisor components 202 and 204) and an enhanced CPU 402 with support for new hardware-assisted virtualization features according to embodiments of the present disclosure. In various embodiments, these new hardware-assisted virtualization features include the following:
1. A first new control structure 404 that is associated with existing control structure 108 and is made accessible to hypervisor 200 while operating in privileged hypervisor mode via kernel level hypervisor component 202. Control structure 404 allows hypervisor 200 to set, for each configurable property/setting of control structure 108, whether the hypervisor can directly access (e.g., read and/or modify) that property/setting when running in unprivileged hypervisor mode via user level hypervisor component 204. In some embodiments, control structure 404 can be implemented as a bitmap where each bit of the bitmap corresponds to a property/setting of control structure 108 and where the value of the bit indicates whether that property/setting is accessible at the user level. In further embodiments, this bitmap can be extended to include two bits per property/setting, where the first bit controls read access to that property/setting and the second bit controls write access to that property/setting.
2. A second new control structure 406 that is also associated with existing control structure 108 and is made accessible to hypervisor 200 while operating in privileged hypervisor mode via kernel level hypervisor component 202. Control structure 406 allows hypervisor 200 to set, for each guest event/operation indicated in control structure 108 as causing an exit to privileged hypervisor mode, whether the CPU should instead exit to unprivileged hypervisor mode and, if so, the program address of user level hypervisor component 204 that the exit should jump to. Like new control structure 404, in some embodiments control structure 406 can be implemented (at least in part) as a bitmap where each bit in the bitmap corresponds to a guest event/operation specified in existing control structure 108.
3. The ability for CPU 102, when running in unprivileged hypervisor mode, to directly transition to a guest execution mode, thereby avoiding the need to first transition to privileged hypervisor mode. For example, in certain embodiments CPU 102 may support one or more new instructions that can be called by user level hypervisor 204 while running in unprivileged hypervisor mode and that allow for a direct transition from unprivileged hypervisor mode to either privileged or unprivileged guest mode.
4. A third new control structure 408 that allows hypervisor 200 to enable or disable features (1)-(3) from the context of privileged hypervisor mode/kernel level hypervisor component 202. In some embodiments, this control structure can be implemented as a single bit where a bit value of 1 indicates that the features are enabled and a bit value of 0 indicates that the features are disabled (or vice versa).

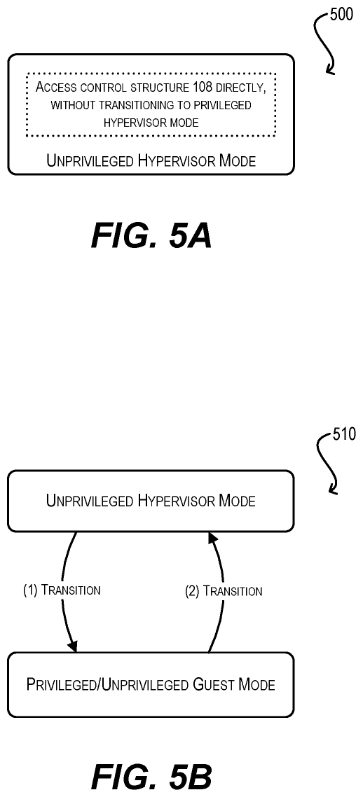

The foregoing new hardware-assisted virtualization features advantageously reduce the number of CPU execution context transitions across privilege levels that are necessitated by user level hypervisor component 204 of hypervisor 200, thereby allowing the hypervisor to reap the benefits of executing certain tasks at the user level (e.g., improved security, simplified architecture, etc.) while at the same time maintaining a high level of performance. For example, FIG. 5A illustrates the CPU transitions (or more precisely, the lack CPU transitions) that occur with respect to the previously discussed scenario of FIG. 3A when the new hardware-assisted virtualization features of the present disclosure are enabled. As shown in scenario 500 of FIG. 5A, in the case where hypervisor 200 is running in unprivileged hypervisor mode via user level hypervisor component 204 at the time of needing to change a particular property/setting in control structure 108, it can perform the changes directly from unprivileged hypervisor mode, without first transitioning to privileged hypervisor mode/kernel level hypervisor component 202, as long as that property/setting is marked as being accessible at the user level in new control structure 404.

And FIG. 5B illustrates the CPU transitions that occur with respect to the previously discussed scenario of FIG. 3B when the new hardware-assisted virtualization features of the present disclosure are enabled. As shown in scenario 510 of FIG. 5B, in the case where hypervisor 200 is running in unprivileged hypervisor mode via user level hypervisor component 204 at the time of needing to switch CPU control to either privileged guest mode or unprivileged guest mode, CPU 102 can directly transition to that guest mode, without first transitioning to privileged hypervisor mode via kernel level hypervisor component 202. Further, upon exiting the guest mode in response to a particular guest event or operation, CPU 102 can transition directly to unprivileged hypervisor mode (and in particular, jump to a particular program address of user level hypervisor component 204), as long as that guest event/operation is marked as allowing for exits to unprivileged hypervisor mode in new control structure 406.

In one set of embodiments, kernel level hypervisor component 202 can enable new features (1)-(3) and configure new control structures 404 and 406 upon startup of hypervisor 200. In alternative embodiments, kernel level hypervisor component 202 can dynamically enable/disable features (1)-(3) and/or dynamically configure/reconfigure control structures 404 and 406 during the runtime of hypervisor 200.

The remaining sections of this disclosure describe workflows that may be implemented by kernel level hypervisor component 202 and user level hypervisor component 204 using the new hardware-assisted virtualization features of enhanced CPU 402 to enable user level hypervisor access to existing control structure 108 and to perform direct unprivileged hypervisor mode to guest mode transitions according to certain embodiments. It should be appreciated that FIGS. 1, 2, 3A, 3B, 4, 5A, and 5B are illustrative and not intended to limit embodiments of the present disclosure. For example, although FIG. 4 depicts a particular arrangement of components within computer system 400, other arrangements are possible (e.g., the functionality attributed to a particular component may be split into multiple components, components may be combined, etc.). For example, in some embodiments new control structures 404, 406, and/or 408 may be merged into fewer control structures or a single control structure. In addition, computer system 400 may include other components or subcomponents that are not specifically described. One of ordinary skill in the art will recognize other variations, modifications, and alternatives.

### 2. User Level Access to Guest Mode Properties/Settings

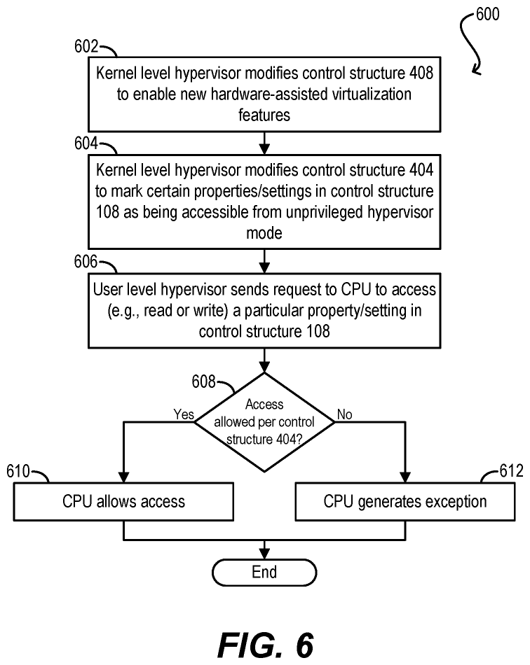

FIG. 6 depicts a workflow 600 that can be executed by kernel level hypervisor component 202 and user level hypervisor component 204 of hypervisor 200 to enable user level access to the guest mode properties/settings of existing control structure 108 using the new hardware-assisted virtualization features of enhanced CPU 402 according to certain embodiments.

Starting with step 602, kernel level hypervisor component 202 can modify control structure 408 to enable the new hardware-assisted virtualization features. In addition, at step 604, kernel level hypervisor component 202 can modify control structure 404 to mark certain properties/settings as being accessible from unprivileged hypervisor mode.

At a later time, user level hypervisor component 204 can send a request (e.g., invoke an instruction) to CPU 102 to read or write a particular property/setting in control structure 108 (step 606). In response, CPU 102 can check control structure 404 to determine whether the read or write operation for that property/setting is allowed (step 608).

If the answer is yes, CPU 102 can proceed with execution the read/write operation on control structure 108 and return an appropriate response to user level hypervisor component 204 (step 610). For example, in the case of a read request, CPU 102 can return the current value of the property/setting in control structure 108. In the case of a write request, CPU 102 can return an acknowledgement indicating that the write operation has been completed successfully. However, if the answer at step 608 is no, CPU 102 can generate and return an error message (e.g., exception) to user level hypervisor component 204 indicating that the requested operation is not allowed (step 612).

### 3. Unprivileged Hypervisor Mode to Guest Mode Transitions

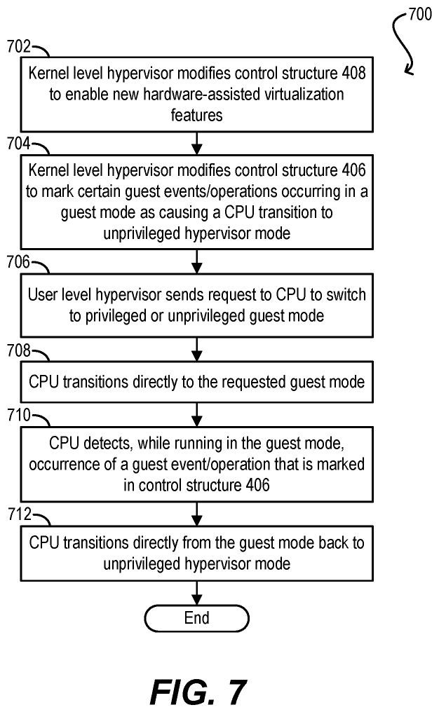

FIG. 7 depicts a workflow 700 that can be executed by kernel level hypervisor component 202 and user level hypervisor component 204 of hypervisor 200 to enable direct unprivileged hypervisor mode to guest mode (and back) transitions according to certain embodiments.

Starting with step 702, kernel level hypervisor component 202 can modify control structure 408 to enable the new hardware-assisted virtualization features. In addition, at step 704, kernel level hypervisor component 202 can modify control structure 406 to mark certain guest events/operations that may occur while CPU 102 is in privileged or unprivileged guest mode as causing an exit/transition from that guest mode directly to unprivileged hypervisor mode. As part of 704, kernel level hypervisor component 202 can set within control structure 406, for each marked guest event/operation, a program address of user level hypervisor component 204 to return to.

At a later time, user level hypervisor component 204 can encounter a scenario in which it would like to transition CPU control to one of the guest modes and thus can send a request to CPU 102 switch to that guest mode (step 706). In certain embodiments, step 706 can comprise invoking a new CPU instruction that specifies this transition (i.e., from unprivileged hypervisor mode to one of the guest modes). In response, CPU 102 can transition directly to the requested guest mode and run appropriate guest code in that execution mode (step 708).

At step 710, CPU 102 can detect, while running in the guest mode, the occurrence of a guest event or operation that is marked in control structure 406 and thus indicates that a transition should occur to unprivileged hypervisor mode. Finally, at step 712, CPU 102 can transition directly from the guest mode to unprivileged hypervisor mode and restart execution at the program address of user level hypervisor component 204 specified for that guest event/operation in control structure 406.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

In addition, while certain virtualization methods referenced herein have generally assumed that virtual machines present interfaces consistent with a particular hardware system, persons of ordinary skill in the art will recognize that the methods referenced can be used in conjunction with virtualizations that do not correspond directly to any particular hardware system. Virtualization systems in accordance with the various embodiments, implemented as hosted embodiments, non-hosted embodiments or as embodiments that tend to blur distinctions between the two, are all envisioned. Furthermore, certain virtualization operations can be wholly or partially implemented in hardware.

Many variations, modifications, additions, and improvements are possible, regardless the degree of virtualization. The virtualization software can therefore include components of a host, console, or guest operating system that performs virtualization functions. Plural instances can be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the present disclosure. In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
modifying, by a kernel level hypervisor component of a hypervisor running on a computer system, a configuration setting in a first control structure maintained in hardware by a central processing unit (CPU) of the computer system, the configuration setting indicating whether a feature of the CPU is accessible by guest code running in a privileged or unprivileged guest mode of the CPU;
modifying, by the kernel level hypervisor component, a second control structure maintained in hardware by the CPU to indicate that the configuration setting included in the first control structure accessible from an unprivileged hypervisor mode of the CPU;
sending, by a user level hypervisor component of the hypervisor, a first request to the CPU to access the configuration setting, wherein the user level hypervisor component runs in the unprivileged hypervisor mode; and
receiving, by the user level hypervisor component, a response from the CPU indicating whether the first request has been processed successfully.

2. The method of claim 1 wherein in response to the first request, the CPU checks whether the configuration setting is indicated as being accessible from the unprivileged hypervisor mode in the second control structure, and
wherein upon determining that the configuration setting is indicated as being accessible from the unprivileged hypervisor mode in the second control structure, the CPU allows the access.

3. The method of claim 2 wherein upon determining that the configuration setting is not indicated as being accessible from the unprivileged hypervisor mode in the second control structure, the CPU generates an error message.

4. The method of claim 1 wherein the second control structure is a bitmap, and wherein modifying the second control structure to indicate that the configuration setting is accessible from the unprivileged hypervisor mode comprises setting a bit in the bitmap associated with the configuration setting.

5. The method of claim 1 further comprising:
modifying, by the kernel level hypervisor component, a third control structure maintained in hardware by the CPU to indicate that a guest event or operation will cause a CPU transition from a privileged or unprivileged guest mode to the unprivileged hypervisor mode;
sending, by the user level hypervisor component, a second request to the CPU to transition to the privileged or unprivileged guest mode, wherein in response to the second request the CPU transitions directly from the unprivileged hypervisor mode to the privileged or unprivileged guest mode, and
wherein upon detecting occurrence of the guest event or operation while running in the privileged or unprivileged guest mode, the CPU directly transitions back to the unprivileged hypervisor mode.

6. The method of claim 5 wherein the modifying of the third control structure includes specifying, for the guest event or operation, a program address of the user level hypervisor component.

7. The method of claim 6 wherein upon transitioning back to the unprivileged hypervisor mode, the CPU resumes execution from the program address specified in the third control structure.

8. A non-transitory computer readable storage medium having stored thereon program code executable by a computer system, the program code embodying a method comprising:
modifying, by a kernel level hypervisor component of a hypervisor running on the computer system, a configuration setting in a first control structure maintained in hardware by a central processing unit (CPU) of the computer system, the configuration setting indicating whether a feature of the CPU is accessible by guest code running in a privileged or unprivileged guest mode of the CPU;
modifying, by the kernel level hypervisor component, a second control structure maintained in hardware by the CPU to indicate that the configuration setting is accessible from an unprivileged hypervisor mode of the CPU;
sending, by a user level hypervisor component of the hypervisor, a first request to the CPU to access the configuration setting, wherein the user level hypervisor component runs in the unprivileged hypervisor mode; and
receiving, by the user level hypervisor component, a response from the CPU indicating whether the first request has been processed successfully.

9. The non-transitory computer readable storage medium of claim 8 wherein in response to the first request, the CPU checks whether the configuration setting is indicated as being accessible from the unprivileged hypervisor mode in the second control structure, and
wherein upon determining that the configuration setting is indicated as being accessible from the unprivileged hypervisor mode in the second control structure, the CPU allows the access.

10. The non-transitory computer readable storage medium of claim 9 wherein upon determining that the configuration setting is not indicated as being accessible from the unprivileged hypervisor mode in the second control structure, the CPU generates an error message.

11. The non-transitory computer readable storage medium of claim 8 wherein the second control structure is a bitmap, and wherein modifying the second control structure to indicate that the configuration setting is accessible from the unprivileged hypervisor mode comprises setting a bit in the bitmap associated with the configuration setting.

12. The non-transitory computer readable storage medium of claim 8 wherein the method further comprises:
modifying, by the kernel level hypervisor component, a third control structure maintained in hardware by the CPU to indicate that a guest event or operation will cause a CPU transition from a privileged or unprivileged guest mode to the unprivileged hypervisor mode;
sending, by the user level hypervisor component, a second request to the CPU to transition to the privileged or unprivileged guest mode, wherein in response to the second request the CPU transitions directly from the unprivileged hypervisor mode to the privileged or unprivileged guest mode, and
wherein upon detecting occurrence of the guest event or operation while running in the privileged or unprivileged guest mode, the CPU directly transitions back to the unprivileged hypervisor mode.

13. The non-transitory computer readable storage medium of claim 12 wherein the modifying of the third control structure includes specifying, for the guest event or operation, a program address of the user level hypervisor component.

14. The non-transitory computer readable storage medium of claim 13 wherein upon transitioning back to the unprivileged hypervisor mode, the CPU resumes execution from the program address specified in the third control structure.

15. A computer system comprising:
a central processing unit (CPU) implementing a plurality of hardware-assisted virtualization features, including:
a first control structure accessible to a kernel level hypervisor component running in a privileged hypervisor mode of the CPU, the first control structure maintaining a plurality of configuration settings pertaining to features of the CPU;
a second control structure accessible to the kernel level hypervisor component, the second control structure allowing the kernel level hypervisor component to set, for each of the plurality of configuration settings maintained in the first control structure, an indication of whether said each configuration setting is accessible by a user level hypervisor component running in an unprivileged hypervisor mode of the CPU;
a third control structure accessible by the kernel level hypervisor component, the third control structure allowing the kernel level hypervisor component to set, for each of a plurality of guest events or operations, an indication of whether said each guest event or operation will cause a CPU transition from a privileged or unprivileged guest mode to the unprivileged hypervisor mode;
a CPU instruction that, when invoked, causes the CPU to transition directly from the unprivileged hypervisor mode to the privileged or unprivileged guest mode; and
a fourth control structure accessible by the kernel level hypervisor component, the fourth control structure allowing the kernel level hypervisor component to enable and disable the second control structure, the third control structure, and the CPU instruction.

16. The computer system of claim 15 wherein each configuration setting in the first control structure indicates whether a feature of the CPU is accessible by guest code running in the privileged or unprivileged guest mode.

17. The computer system of claim 15 wherein in response to receiving a request to access a configuration setting in the first control structure by the user level hypervisor component, the CPU checks whether the configuration setting is indicated as being accessible from the unprivileged hypervisor mode in the second control structure, and
wherein upon determining that the configuration setting is indicated as being accessible from the unprivileged hypervisor mode in the second control structure, the CPU allows the access.

18. The computer system of claim 17 wherein upon determining that the configuration setting is not indicated as being accessible from the unprivileged hypervisor mode in the second control structure, the CPU generates an error message.

19. The computer system of claim 15 wherein in response to receiving an invocation of the CPU instruction from the user level hypervisor component, the CPU transitions directly from the unprivileged hypervisor mode to the privileged or unprivileged guest mode, and
wherein upon detecting, while running in the privileged or unprivileged guest mode, occurrence of a guest event or operation that is indicated in the third control structure, the CPU directly transitions back to the unprivileged hypervisor mode.

20. The computer system of claim 19 wherein the guest event or operation is associated with a program address of the user level hypervisor component in the third control structure.

21. The computer system of claim 20 wherein upon transitioning back to the unprivileged hypervisor mode, the CPU resumes execution from the program address specified in the third control structure.
